(19) United States
(12) Patent Application Publication
(10) Pub. No.: US 2009/0148634 A1
(43) Pub. Date: Jun. 11, 2009

(54) Insert and Injection-Molded Part Having an Insert

(75) Inventors: Matthias Fuertsch, Gomaringen (DE); Lutz Mueller, Aichtal (DE); Dagmar Stolpmann, Bad Teinach-Zavelstein (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/086,666

(22) PCT Filed: Dec. 12, 2006
(86) PCT No.: PCT/EP2006/069569

§ 371 Date: Dec. 19, 2008

(30) Foreign Application Priority Data
Dec. 23, 2005 (DE) 10 2005 061 889.8

(51) Int. Cl. B32B 15/04; B32B 1/00

(52) U.S. Cl. 428/34.1; 428/450; 428/332

(57) ABSTRACT

An insert in an injection-molded part is provided, in particular a fastening bush for accommodating a fastening means in a receptacle opening, having at least one outer surface. At least the outer surface has a metallic anticorrosion layer on which a sealing layer is deposited.

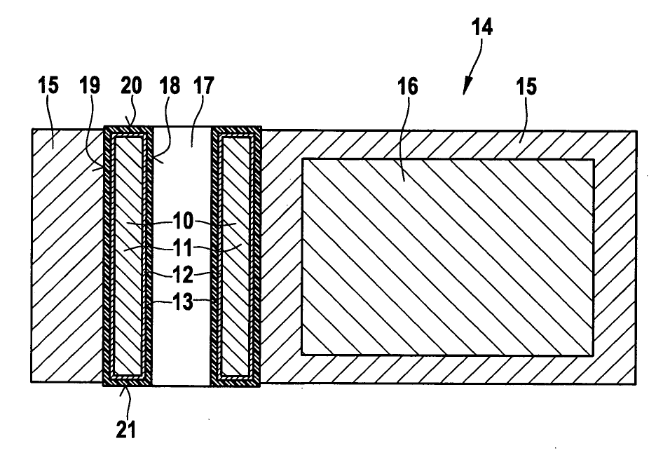

### FIELD OF THE INVENTION

The present invention is directed to an insert into an injection-molded part, and an injection-molded part having an insert.

### BACKGROUND INFORMATION

Housings used, for example, for sensors in motor vehicles are usually screwed on. To prevent the housing from being crushed by the pretensioning force of the screw, force-transmitting fastening bushes extruded into the housing are used. These bushes are designed as cylindrical tubular sections and conduct the tension from the fastening screws into the housing. The fastening bushes are usually made of metals such as brass, aluminum, stainless steel, galvanized steel, and the like.

It is known to extrusion-coat the fastening bushes with a polymeric housing material, which corresponds to a typical method for producing sensor housings. Polybutylene terephthalate (PBT) is frequently used as a housing material.

Attack of the fastening bushes by corrosive media, for example salt spray mist, causes corrosion which may damage the housing material. When fastening bushes and screws are made from different metals, local cell corrosion also occurs. Although this may be avoided by electrically insulating the metal parts from one another, crevice corrosion may still occur since the enclosure of the fastening bush by the housing material is not entirely free of gaps. Crevice corrosion also occurs when the fastening bush and screws are made of similar materials. The corrosion products from both types of corrosion may damage the housing material.

### SUMMARY OF THE INVENTION

An insert, in particular a fastening bush, is provided in an injection-molded part for accommodating a fastening means in a receptacle opening, at least the outer surface of the insert having a metallic first anticorrosion layer on which a sealing layer is deposited. A metallic insert in the form of a fastening bush provides high pressure resistance as a result of the metallic fastening bush, and provides good corrosion protection as a result of the anticorrosion layer. By providing the fastening bush in a sensor housing, a stable attachment may be achieved without damaging the housing. The fastening bush is preferably made of steel. The sealing layer further increases the corrosion protection, and is able to reduce any delamination gaps between the insert and the injection-molded material. At the same time, the sealing layer is used to electrically insulate the insert. Local cell corrosion as well as crevice corrosion may thus be avoided.

In one advantageous design a lacquer layer is provided as the sealing layer.

In one particularly advantageous design, the lacquer layer is a cathodic dip lacquering layer (cataphoretic dip lacquer (CDL)) using a CDL lacquer. In one particularly advantageous combination using a Zn layer and in particular a ZnNi layer, the system of two coatings provides increased corrosion protection. Particularly good adhesion between the injection-molded material and the CDL lacquer results in particular when the coated insert is extrusion-coated with a polymeric material, in particular a housing material such as polyamide or polybutylene terephthalate. This provides even better sealing of any delamination gaps between the insert and the injection-molded material.

Alternatively, the sealing layer may be a silicate- or organosilicate-based layer. The sealing layer preferably has a layer thickness of greater than 0.5 μm, preferably at least 1 μm. The sealing layer also has sufficient temperature stability, which ensures that the sealing layer does not degrade under the influence of elevated temperatures during injection molding with the polymeric material. The sealing layer is still present after extrusion coating, and ensures increased stability against local cell corrosion and crevice corrosion.

In one advantageous design, the insert has a sleeve-shaped body which is enclosed at its inner and outer surfaces by the anticorrosion layer and the sealing layer deposited thereon. The two layers are likewise deposited on the end faces in such a way that onset of corrosion may be largely prevented as the result of the complete encapsulation of the body. The insert may have an internal thread via which the insert and connected enclosures, for example an injection-molded housing, may be screwed directly to a support, for example a vehicle body.

In one advantageous design, the anticorrosion layer is a Zn layer. It is particularly advantageous for the anticorrosion layer to be a ZnNi layer. This layer may be advantageously applied by electroplating, thus allowing the metallic insert to be coated with a dense, well-adhering coating of the anticorrosion layer. ZnNi in particular provides good protection against corrosive media such as salt spray mist.

In one advantageous refinement the insert has a rotationally fixed design, at least with respect to its sleeve-shaped body. The insert is protected against sliding through the injection-molded material when a screw is screwed into the insert. The sleeve-shaped body advantageously has a polygonal cross section, preferably a hexagonal profile. The sleeve-shaped body may also have a cross section with a knurled profile. The adhesion between the sealing layer and the injection-molded material is maintained by the fact that the insert is prevented from sliding through during tightening of a fastening screw, for example. Subsequent appearance of corrosion-causing crevices at the boundary layer between the sealing layer and the injection-molded material during installation of the injection-molded part, for example in the form of a sensor housing in a vehicle, is prevented. A screw-on injection-molded housing which has an integrated fastening bush and is resistant to corrosion under high thermal and mechanical stress, and which thus advantageously protects sensors installed in the vehicle, may thus be provided in particular for automotive applications.

Also provided is an injection-molded part containing an insert, the insert being designed in particular as a fastening bush for accommodating a fastening means in a receptacle opening. At least the outer surface of the insert has a metallic first anticorrosion layer on which a sealing layer is deposited.

In one advantageous design, the insert which is coated with an anticorrosion layer and a sealing layer is extrusion-coated with at least one material from the group including polybutylene terephthalate, polyamide, and/or fiberglass-filled polymer. The anticorrosion layer is preferably provided as an electroplated Zn layer or a layer composed of a ZnNi alloy, and the sealing layer is cathodically applied as a CDL lacquer or as a silicate-based layer via dip coating. The insert may advantageously have a rotationally fixed cross section.

The injection-molded part also has an attractive appearance, since both the injection-molded material and the insert provided with a CDL layer usually have a black color, in particular when a ZnNi anticorrosion layer is present.

The injection-molded part is preferably designed as a housing having an integrated fastening bush. One preferred use of the injection-molded part is as an automotive sensor housing.

### BRIEF DESCRIPTION OF THE DRAWING

The FIGURE shows a section of a preferred injection-molded part, designed in the form of a housing, having an integrated preferred insert.

### DETAILED DESCRIPTION

The FIGURE schematically shows a section of an injection-molded part 14 as an example, which is used as a housing for a sensor 16 which, for example, is screwed into a motor vehicle. An insert 10 designed as a fastening bush and having a sleeve-shaped body 11 which is preferably metallic and made of steel, for example, is provided for attachment. Sleeve-shaped body 11 advantageously has a rotationally fixed design, for example with a hexagonal or knurled cross section.

For accommodating a fastening means (not shown) designed as a screw, for example, insert 10 has a receptacle opening 17. At its inner and outer surfaces 18, 19 and its upper and lower end faces 20, 21, sleeve-shaped body 11 is coated with a metallic anticorrosion layer 12 on which a sealing layer 13, preferably a lacquer layer 13′ or a silicate-based layer, for example, is deposited. Lacquer layer 13′ is preferably a CDL layer which is applied via a cathodic dip lacquering process.

First anticorrosion layer 12 is preferably a Zn layer, particularly preferably a ZnNi alloy layer. A thickness of several micrometers, for example, is practical. This anticorrosion layer 12 is preferably applied by electroplating in a customary manner.

A passivation layer may also optionally be deposited on anticorrosion layer 12. Insert 10 is then coated with sealing layer 13, and is then extrusion-coated with a polymer.

Sealing layer 13 may preferably be applied as a silicate layer via dip coating. Sealing layer 13 is temperature-resistant and should have a sufficient thickness, preferably at least 0.5 μm, particularly preferably at least 1 μm, to avoid degradation of sealing layer 13 during the subsequent injection molding. A lacquer layer 13′ may preferably be cathodically deposited (CDL layer) as a sealing layer 13.

Insert 10 is placed in an injection molding tool and is extrusion-coated with a polymeric injection-molded material 15, for example PBT. PBT adheres very well to the CDL layer and fuses with same. In this manner, potential delamination gaps between injection-molded material 15 and insert 10 or its lacquer layer 13 are minimized. Extrusion-coated insert 10 may then be combined with sensor 16, which may likewise be extrusion-coated, or sensor 16 and insert 10 are simultaneously extrusion-coated in the injection molding tool to form an injection-molded housing having an integrated insert bush.

1-15. (canceled)

16. An insert in an injection-molded part for accommodating a fastening element in a receptacle opening, the insert comprising:
at least one outer surface having a metallic anticorrosion layer; and
a sealing layer deposited on the anticorrosion layer.

17. The insert according to claim 16, wherein the insert is a fastening bush.

18. The insert according to claim 16, wherein the sealing layer is a silicate- or organosilicate-based layer.

19. The insert according to claim 18, wherein the sealing layer has a layer thickness of greater than 0.5 μm.

20. The insert according to claim 19, wherein the layer thickness is at least 1 μm.

21. The insert according to claim 16, wherein the sealing layer includes a lacquer layer.

22. The insert according to claim 16, further comprising a sleeve-shaped body which is enclosed at its inner and outer surfaces by the anticorrosion layer and the sealing layer.

23. The insert according to claim 21, wherein the lacquer layer is a cathodic dip lacquering layer.

24. The insert according to claim 16, wherein the anticorrosion layer is a ZnNi layer.

25. The insert according to claim 16, wherein the anticorrosion layer is a Zn layer.

26. The insert according to claim 22, wherein the sleeve-shaped body has a rotationally fixed design.

27. The insert according to claim 26, wherein the sleeve-shaped body has a cross section with a polygonal profile.

28. The insert according to claim 26, wherein the sleeve-shaped body has a cross section with a knurled profile.

29. An injection-molded part comprising:
an insert for accommodating a fastening element in a receptacle opening, having at least one outer surface,
wherein the insert, at least on the outer surface, has a metallic first anticorrosion layer and a sealing layer deposited on the first anticorrosion layer.

30. The injection-molded part according to claim 29, wherein the insert is a fastening bush.

31. The injection-molded part according to claim 29, wherein the insert which is coated with the anticorrosion layer and the sealing layer is extrusion-coated with at least one material from the group including polybutylene terephthalate, polyamide, and fiberglass-filled polymer.

32. The injection-molded part according to claim 29, wherein the part has a design as a housing having an integrated fastening bush.

33. The injection-molded part according to claim 29, wherein the part is used in a sensor housing.
